(19) United States
(12) Patent Application Publication
(10) Pub. No.: US 2012/0261295 A1
(43) Pub. Date: Oct. 18, 2012

(54) METHOD FOR THE PRODUCTION OF AUTOCLAVED FOOD IN A RECEPTACLE FORMED FROM A LAMINATE COMPRISING A COLORED CROSS-LINKED OUTER POLYMER LAYER OBTAINED IN A GRAVURE PRINTING PROCESS

(75) Inventors: Michael Wolters, Heinsberg (DE); Dirk Schibull, Heinsberg (DE)

(73) Assignee: SIG TECHNOLOGY AG, Neuhausen (CH)

(21) Appl. No.: 13/503,157

(22) PCT Filed: Oct. 22, 2010
(86) PCT No.: PCT/EP2010/006460

§ 371 Date: Jun. 29, 2012

(30) Foreign Application Priority Data
Oct. 22, 2009 (DE) 10 2009 050 418.4

(51) Int. Cl. B65D 85/00; B32B 27/32; A23L 1/00; B32B 27/36; B32B 27/30; B65B 63/08; B32B 27/34

(52) U.S. Cl. 206/459.5; 53/440; 428/523; 428/474.4; 428/480; 428/500; 426/531

(57) ABSTRACT

Disclosed is a method for producing a closed receptacle that seals an interior from surroundings, is filled with food, and is made from at least one laminate comprising at least one edge. Said method includes the following steps: f) providing the laminate that includes: a1) at least one outer cross-linked colored plastic layer containing a dye and a polyaddition product; a2) a support layer; and a3) a thermoplastic material layer; g) forming the laminate so as to obtain an open receptacle in which the colored plastic layer faces the surroundings and the plastic layer faces the interior; h) filling the open receptacle with food; i) closing the open receptacle so as to obtain the closed, filled receptacle; preserving the food in the closed, filled receptacle in a pressure chamber at a chamber pressure exceeding 1 bar and at a temperature ranging from more than 100 to 140° C. in the presence of steam.

In general, the invention concerns a process for the preparation of a closed, filled container with at least a sheet-like composite having at least one edge, comprising the steps: Provision of a sheet-like composite, comprising a1. at least an outer cross-linked plastic colour layer which comprises colour agent, a2. a carrier layer, and a3. a thermoplastic plastic layer; shaping of the sheet-like composite to obtain an open container, filling of the container with a food stuff, closing of the container to obtain a closed, filled container, as well as the preservation thereof.

For a long time the preservation of food stuffs, be they food stuffs for human consumption or animal feed products, has been achieved by storing them in a tin or in a glass jar closed with a lid. In this connection, one way to achieve storage life is to separately sterilise as far as possible both the food stuff and the container, here the glass jar or the tin, and then fill the food stuff into the container and close the container. In another approach the food stuff is filled into the glass jar or tin and then sterilised as far as possible using heat treatment and the glass jar or tin sealed. In a further approach the food stuff is filled into the glass jar or tin and the glass jar or tin is sealed. Subsequently the sealed tin or closed glass jar with the food stuff present therein is exposed to a heat treatment, referred to as pasteurisation, sterilisation or autoclaving, preferably an autoclaving mainly using superheated steam, in order to sterilise as far as possible the food stuff as well as the inner walls of the container which face onto the food stuff and the side of the sealing wall of the tin or the lid of the glass jar which faces onto the food stuff However, these measures for increasing the storage life of food stuffs, which have for a long time proven valuable, have a number of disadvantages. Tins and glass jars have the disadvantage, due to their essentially cylindrical shape, that a close, space saving packing is not possible. In addition, tins and jars themselves have a considerable weight of their own, which leads to an increased energy expenditure in transportation. Moreover, the production of glass, tin or aluminium, even when raw materials come from recycling, requires a very high energy expenditure. To make matters worse where glass jars are concerned, there is additionally an increased transport expenditure. The glass jars are normally fabricated in a glassworks and must then be transported to the food stuff filling plant, the transport volume occupied being considerable. Furthermore, glass jars and tins can only be opened with considerable effort or with the help of tools, which is therefore laborious. With tins there is additionally a high risk of injury from sharp edges produced during opening. Time and time again with glass jars, slivers of glass get into the food stuff during the filling of glass jars or the opening of filled glass jars, which in the worse case can lead to internal injury on consumption of the food stuff.

Another concept for the storage of long life food stuffs is known from the prior art. Here containers are used which are made out of a multi layer sheet-like composite, often referred to as a laminate, in which particularly stiff paper, card or cardboard forms a carrier layer which governs the form stability of these packagings. This type of packaging is disclosed, for example, in WO 97/02140, which discloses a process for the preparation of a folded, heat and moisture resistant container which is treated with the so called “Hot fill”-process (cf. Ullmann's Encyclopaedia of Industrial Chemistry, Vol. A 11, “FOODS”, 2. “Food Technology, 1988, sides 549 and 552, VCH Verlagsgesellschaft Weinheim). A further container made of a sheet-like composite with cardboard as carrier layer is disclosed by WO 97/02181. Another container concept, similarly belonging to this group of containers made out of a sheet-like composite with cardboard as carrier layer, is disclosed by DE-OS-24 12 447. WO 03/059622 A2 also discloses a container concept made of a sheet-like composite with cardboard as carrier layer which is used for autoclaving.

These containers are often furnished with printed pictures or coloured decorations which, as well as providing information on the content of the container, are also supposed to make important aesthetic impressions on the end user of the food stuff contained in the container. It is particularly disadvantageous if these printed pictures suffer the most drastic of conditions during the preservation through autoclaving. In order to prevent this at least partially, WO 02/22462 A1 proposes the use of a protective finish introduced onto the colour layer. Similar concepts for a protective layer over the colour are also proposed by DE 102 52 553 B4, WO 98/51493 A1 as well as WO 2008/094085 A1.

In general, the inventive object of the present invention lies in the at least partial elimination of the disadvantages present in the prior art.

The present object was additionally to establish a process which allows the preparation of a closed, filled, and autoclaved container at minimal expense and with as little damage as possible to the printed pictures or colour decorations. As well as scratching and detachment of the printed pictures or colour decoration, a washing out of the colour during autoclaving should be avoided as far as possible, in order to ensure such a high autoclave resistance. In this connection, the process speed should remain as high as possible should allow the preparation in as few printing facilities as possible, preferably in only one printing facility, preferably in continuous operation, and should ensure the high suitability of the container for receiving food stuffs.

A contribution to the solution of at least one of the present objects is made by the subject matter of the category forming claims and subsequent embodiments. The subject matter of the sub claims which are dependent on the category forming claims represents preferred embodiments of this contribution to the solution.

A contribution to the solution of at least one of the present objects is made by a process for the preparation of a closed container, filled with food stuff, which closes off an internal space from an environment made of at least a sheet-like composite which has at least one edge, comprising the steps:
a) provision of the sheet-like composite, comprising
   a1. at least one outer, preferably outermost, cross-linked plastic layer which comprises colour agents, wherein the plastic colour layer (9) comprises a poly addition product;
   a2. a carrier layer; and
   a3. a thermoplastic plastic layer;
b) formation of the sheet-like composite to obtain an open container, wherein the plastic colour layer faces onto the environment and the plastic layer faces onto the internal space;
c) filling of the open container with the food stuff;
d) closing of the open container to obtain the closed, filled container;
e) preservation of the food stuff in the closed, filled container in a pressure chamber at a chamber pressure of more than 1 bar at a temperature in a range from more than 100 to 140° C. in the presence of steam.

As poly-addition product, all those known to the person skilled in the art and which seem to them to be suitable for the process according to the invention come into consideration. In contrast to the chain polymerisates, the monomers of the poly-addition products are able to react with each other to form di- tri- or oligomers without the need for an initiator which, as with radical polymerisation, starts a reaction of a monomer which then successively reacts with other monomers. The di, tri- or oligomers which are formed at the start of the polyaddition are additionally able to react with each other to form larger units. Typical poly-addition products are polyamides, polycarbonates, polyesters, polyphenylenoxides, polysulphones, polyepoxides or polyurethanes or a combination of at least two thereof, particularly preferred poly-addition products being those composed at least 50% by weight, preferably at least 70% by weight and particularly preferably 90% by weight of polyurethane, in each case based on the poly-addition product.

In a further embodiment according to the invention those poly-addition products are particularly preferred which consist of at least 50% by weight, preferably at least 70% by weight and particularly preferably at least 90% by weight, in each case relative to the poly-addition product, of a polyalkylalcohol, the OH groups of which are at least partially, preferably at least 50%, esterified with a carboxylic acid, preferably a C2 to C10 carboxylic acid, and which also have two O-atom carrying six membered rings in the polymer chain (hereafter referred to as polyalcohol poly-addition product). Here, polyvinylbutyral (PVB), commercially obtainable from Kuraray under the trade name Mowital™, is particularly preferred as poly-addition product.

In another embodiment according to the invention, those poly-addition products are preferred which are composed of at least 50% by weight, preferably at least 70% by weight and particularly preferably at least 90% by weight, in each case in relation to the poly-addition product, of a cellulose derivative, in particular of a cellulose ester or nitrocellulose (NC) or a mixture of both. As cellulose ester, esterification products of the cellulose with one or at least two different carboxylic acids, preferably with C2 to C10 carboxylic acids, come into consideration. Esterification products with two and more carboxylic acids are preferred wherein one of the at least two carboxylic acids forms an acetate and the other carboxylic acid possesses more than two C-atoms. In this connection celluloseacetatepropionate (CAP) or celluloseacetatebutyrate (CAB) or a mixture of these two are preferred. These products are obtainable, for example, from Eastman under the trade names CAP and CAB.

It is further preferred that the plastic colour layer consists at least 50% by weight, preferably at least 70% by weight and at particularly preferably at least 90% by weight, in each case relative to the plastic colour layer, of the poly-addition product. However, the plastic colour layer generally comprises no more than 99% by weight of the poly-condensation in order to be able to contain other materials.

According to the invention, the outer layer can by all means have further layers between the outer layer and the environment. The outermost layer, however, according to the invention, is in direct contact with the environment and no further layers, particularly protective layers, are present in between the outer layer and the environment. The outer plastic colour layer and the outermost plastic colour layer, along with the corresponding sheet-like composite, unfilled and filled container prepared therefrom, and preservation process, each constitute an embodiment according to the invention.

The containers according to the invention preferably have between 6 and 16 edges, preferably between 7 and 12 edges. According to the invention, edges will be particularly understood as areas arising from the folding of a surface where two parts of this surface are overlapping. For example, the oblong contact areas, in each case between two wall surfaces in an essentially cuboid container, are named edges. Such a cuboid container has, as a general rule, 12 edges. In the container according to the invention the walls of the container preferably represent the surfaces of the container which are bordered by edges. The container walls of a container according to the invention preferably have at least 50%, preferably at least 70% and most preferably 90%, of their area formed of a carrier layer.

Generally, the carrier layer of the container according to the invention can be made of those materials know by the person skilled in the art to be suitable for this purpose, which have sufficient rigidity and stiffness so as to give the container such stability that the container essentially maintains its form when filled. Along with a series of plastics, plant based fibrous materials are also preferred, in particular pulps, particularly glued laminated pulps, cardboard being particularly preferred.

In the container according to the invention the carrier layer forms a part of a sheet-like composite, which can also be referred to as a laminate, and is deployed in the form of an arch, jacket, or a long sheet during the preparation of the container.

The sheet-like composite normally has at least one, or even 2 to 4 further thermoplastic plastic layers. Here all plastics come into consideration which are commonly known to the person skilled in the art, which can be melt extruded and which do not contribute to the delamination of the sheet-like composite under the conditions of the autoclaving. In this connection, preferred thermoplastics are polymers such as polyethylene (PE), polypropylene (PP), polyamide (PA), polyethyleneterephtalate (PET), ethylenevinylalcohol (EVOH), and/or liquid crystal polymers (LCP) or a mixture of at least two thereof. Furthermore, it is preferred for the further plastic layer(s) to have a weight per surface area in a range from 2 to 120 g/m², preferably in a range from 5 to 75 g/m² and particularly preferably in a range from 10 to 55 g/m². It is further preferred that the further plastic layer(s) have a thickness in a range from 10 to 100 μm, preferably in a range from 15 to 75 μm and particularly preferably in a range from 20 to 50 μm.

Furthermore, the sheet-like composite can have one or more adhesive layers. These serve in particular to better bind the carrier layer to the barrier layer which is normally present. In principle, all materials known to the person skilled in the art and which are suited to binding through chemical bonding come into consideration as the adhesive, in particular those functionalised with OH—, NH₂—, COOH— or anhydride groups, preferably plastics which can be melt extruded, in particular maleic acid ethylene copolymers. Such adhesive agents come under the trade names Orevac™, Admer™, Lotader™ or Plexar™. Different adhesive agents can also be mixed together to form a mixed adhesive agent.

Furthermore it is preferred for the container according to the invention to be sealable using a portion of the container wall. One way to achieve this is for the relevant area of the container wall to have foldable or bendable areas by virtue of which it may be sealed by pre-creasing and folding shut as well as fixing of the folded shut portion of the container wall. The fixing which seals the container can be achieved by sealing or bonding or a combination of both of these measures, and so securely that the container sealed in this way can not be readily opened in this area and a long storage life of the food stuff is obtained. The opening along the perforation before use of the food stuff can as such be much easier.

In another embodiment of the container of the process according to the invention it is preferred that at least 70% by volume, preferably at least 75% by volume and more preferably at least 80% by volume, of the volume of the container is made up of food stuff with an F₀ value from 0.01 to 50 and preferably in a range from 2 to 45.

Furthermore, in another embodiment of the container of the process according to the invention, the container wall is formed from a single carrier layer as part of the sheet-like composite. Here, the container can also, for example, be formed in its side walls of a sheet-like composite which has only a single carrier layer, the composite layer being fitted on the over and under side with a cap and a bottom made of another material.

In another form of the container of the process according to the invention, it is formed totally, preferably in one piece, out of a single carrier layer as part of the sheet-like composite. This applies in particular to cuboids containers, also referred to as “brick” as well as cuboid containers that possess a so called “gable-top” mainly used for opening.

According to a further embodiment, the container in the closed state is suitable for the storage of food stuffs. Such containers according to the invention which are closed and filled with food stuff allow this food stuff to be stored for a particularly long period of time.

The forming of the sheet-like composite and the obtaining of an open container can be achieved by any method which seems appropriate therefor by the person skilled in the art. In particular, the forming can be achieved by folding container blanks in sheet form which, in their pre-cut form, already take account of the form of the container in such a way that, via a jacket, an open container according to the invention is formed. This is generally achieved in such a way that, following the folding of this container blank, the longitudinal edges of which are sealed or crimped into a jacket so as to form a side wall, one side of the jacket is closed by folding and further fixing, in particular, sealing or bonding.

In another embodiment of the process according to the invention, first a tube shaped structure with a fixed longitudinal seam is formed by folding and sealing or bonding of the overlapping hems. This tubular structure is laterally compressed, fixed and divided and thus an open container is likewise form by folding and sealing or bonding. Here, the food stuff can already be present after the fixing and before the division.

The open containers obtained in such a way can be filled with food stuff in different ways. In the process according to the invention it is further preferred that at least 70% by volume, preferably at least 75% by volume and even more preferably at least 80% by volume of the volume of the container consist of food stuff.

The closing of the container filled with food stuff is preferably achieved by the folding and sealing or bonding of the portion which is present for this purpose in the open container, which preferably is likewise made out of the carrier layer or the sheet-like composite. Instead of sealing with a sealant plastic, in another embodiment of the process according to the invention other forms for the attachment are possible, for example by the application of a suitable bonding agent or adhesive which is normally a functionalised polymer and thus, in contrast to the physical binding of the sealing, also contributes a chemical bonding of the areas of the container according to the invention which are to be joined.

The preparation of the sheet-like composite can be achieved by any means which seem suitable to the person skilled in the art for manufacture of the container according to the invention. Thus the sheet-like composites can come in the form of a long sheet, normally unrolled from a roll, in the form of a tube or in the form of a container blank or jacket in a pre-cut form with already takes account of the form of the container.

In connection with the sheet-like composite it is preferable that the at least one barrier layer is joined to the carrier layer via a bonding layer. The sheet-like composite can be manufactured by any means which seem suitable to the person skilled in the art. Particularly preferred in this connection is for the individual layers to be worked together into the sheet-like composite via a co-extrusion process.

All materials known to the person skilled in the art which have a low gas permeability come into consideration for barrier layers. Barrier layer(s) made of a foil or further polymer layer such as polyethylenevinylalcohol (EVOH) are preferred. The foil can be a metal foil, a metallised foil, a silicon oxide gas-coated foil or a carbon gas-coated foil.

In a further embodiment of the process according to the invention the food stuff is preserved in the closed, filled container up to an F₀ value from 0.01 to 50 and preferably from 2 to 45.

Further, in an embodiment of the process according to the invention, the preservation is carried out under a chamber pressure of preferably at least more than 1.1 bar, preferably at least 1.2 bar and was also carried out in a range from 1.3 to 4 bar at a temperature in a range from preferably more than 102 to 137° C. and preferably in a range from 105 to 135° C. in the presence of steam. The duration of this preservation depends on the type, amount, volume, lump size of solid parts, viscosity and acidity of the food stuff. In general, the conditions are selected by the person skilled in the art such that the required F₀ values are attained. Normally the preservation is achieved with a holding time in a range from 0.5 seconds to 90 minutes, preferably 2 to 60 minutes and particularly preferably 5 to 40 minutes. It has proven particularly advantageous in the process according to the invention for the container to be agitated during the preservation. Through this agitation, which can for example be a rotation, tumbling and shaking, a mixing of the food stuff in the container, which often has solid and liquid components, is achieved and in this way a distribution of heat in the food stuff contained in the container is achieved which is as good and quick as possible and an adherence of clumped food stuff in the neck of the filled container according to the invention through local over-heating is avoided. Suitable means and equipment for the agitation of the container during the preservation is given, for example, in WO 2009/040347 A2.

In the method according to the invention it is preferred that the sheet-like composite is obtainable by a series of steps comprising:
provision of a pre-composite with a surface, comprising the carrier layer;
application of a liquid colour layer precursor solution onto the surface; and
curing of the coloured layer precursor into the plastic layer colour layer.

In connection with the pre-composite, which is also present in a sheet-like form, it is preferred, just as was the case for the previously described sheet-like composite, that it comprises, in addition to the carrier layer, at least one barrier layer, at least one further plastic layer and at least one adhesive layer. For this purpose, the aforementioned designs for the sheet-like composite are equally valid. The pre-composite often contains all of the layers of the sheet-like composite except for the outermost plastic colour layer.

Further, it is preferred in the process according to the invention that, before the application of the liquid colour layer precursor onto the surface, the surface is treated with a plasma. All plasma treatments known to the person skilled in the art which are suitable for increasing the hydrophilic nature of the surface come into consideration. In this way mostly peroxide, ketone, carboxyl, and other oxygen compounds are formed by the plasma treatment. In another embodiment according to the invention the surface of the pre-composite is at least partially, preferably completely, formed of aluminium. Here the pre-composite often has an aluminium layer which is often present in the sheet-like composite bordering onto the plastic colour layer. Furthermore, it is preferred in one such embodiment of the sheet-like composite/pre-composite that this aluminium layer is joined to the other components of the composite/pre-composite via an adhesive layer or via a layer of thermoplastic plastic. As adhesive agents and thermoplastic plastics, all those described here come into consideration. In this way, a container with a good autoclave resistance can be produced by the process according to the invention.

Furthermore, it is preferred in the process according to the invention, that the surface has a surface tension in a range from 36 to 44 Dyne and particularly preferably from 40 to 41 Dyne in accordance with DIN EN 14210/14370. Where the surface tension is too low, separation of the outer or outermost plastic colour layer can too easily occur, whereas where the surface tension is too high, organoleptic disadvantages can occur, especially if the sheet-like composites are stored for a long time as rolls or stacks.

Moreover, it is preferred in the process according to the invention that the colour layer precursor has a temperature during application in the range from 25 to 40° C., preferably in the range from 26 to 32° C. and particularly preferably in the range from 27 to 29° C. This also has an advantageous effect on the autoclave resistance.

Further, it is preferred in the process according to the invention that the liquid colour layer precursor has a viscosity in the range from 0.05 to 0.3 Pas and preferably in a range from 0.1 to 0.2 Pas. The viscosity is determined using a rotary viscosimeter in accordance with DIN 53019-1. The application of the colour layer precursor with such a viscosity leads to a uniform colour agent precursor layer. This has an advantageous effect on the autoclave resistance of the outer or outermost plastic colour layer.

Furthermore, it is preferred in the process according to the invention that the colour layer precursor solution comprises
FL1 a di- or polyalcohol, preferably di- and polyalcohols,
FL2 a di- or polyisocyanate, preferably di- and polyisocyanates,
FL3 a colour agent,
FL4 20 to 90% by weight, preferably in the range from 50 to 85% by weight and particularly preferably in the range from 65 to 80% by weight in relation to the colour layer precursor solution, of a solvent, and
FL5 optionally additives different from FL1 to FL4.

Furthermore, it is preferred in an embodiment according to the invention that the colour layer precursor solution comprises as components
FLa1 in a range from 2 to 30% by weight, preferably in a range from 5 to 20% by weight and particularly preferably in a range from 10 to 15% by weight, in each case in relation to the colour layer precursor solution, of a di- or polyalcohol, preferably di- and polyalcohols;
FLa2 less than 30% by weight, preferably in a range from 2 to 20% by weight and particularly preferably in a range from 5 to 10% by weight, in each case in relation to the colour layer precursor solution, of a di- or polyisocyanate, preferably di- and polyisocyanates;
FLa3 less than 30% by weight, preferably in a range from 2 to 20% by weight and particularly preferably in a range from 5 to 15%, in each case in relation to the colour layer precursor solution, of a colour agent;
FLa4 less than 15% by weight, preferably less than 10% and particularly preferably less than 5% by weight, in each case in relation to the colour layer precursor solution, of additives different from FL1 to FL3 and FL5; and
FLa5 at least one solvent in an amount as a proportion of the colour layer precursor solution selected in such a way that the sum of all the components FLa1 to FLa5 is equal to 100% by weight.

Die following embodiments of FL1 to FL3 apply equally to FLa1 to FLa3 and FLp1 to FLp3. The embodiments of FL4 apply to FLa5 and FLp5 and the embodiments of FL5 apply to FLa4 and FLp4. For FLp3, the corresponding embodiments of the inorganic particles suitable for the primer apply.

As di- or polyalcohols FL1, all those known to the person skilled in the art for polyurethane formation and which seen to him to be suitable for the process according to the invention come in to consideration. Examples of these are sugars, such as isomalt, sorbitol or mannitol, aliphatic alcohols, such as 1,2-ethandiol, 1,2-propandiol, 1,2,3-propantriol, pentaerythritol, polyesterpolyols or polyetherpolyols, in particular polyethyleneoxide (EO) or polypropyleneoxide (PO), or at least two thereof, polyesterpolyols or polyetherpolyols or combinations thereof being particularly preferred, and polyetherpolyols being still further preferred. The poly-addition products described here individually or as a mixture of at least two thereof are both equally suitable, in particular PVB, CAP or CAB individually or as a mixture of at least two of the afore mentioned. Further, it is preferred that the poly-addition products described here, cellulose esters in particular, are deployed in the presence of an aldehyde resin, particularly in the case of the colour agent layer precursor solution. In the case of the primer layer precursor solution it is preferable to combine the poly-addition products described here, in particular the polyalcohol poly-addition product, with polyetherpolyols.

As di- or polyisocyanate FL2, all those which are known to the person skilled in the art for the polyurethane formation and which seem to him to be suitable for the process according to the invention come into consideration. Examples of these are diphenylmethandiisocyanate (MDI), polymeric diphenylmethandiisocyanate (PMDI), toluylenediisocyanate (TDI), naphthylenediisocyanate (NDI), hexamethylenediisocyanate (HDI), isophoronediisocyanate (IPDI) or 4,4′-diisocyanatodicyclohexylmethane (H12MDI) or at least two thereof.

In connection with the mixture ratio of FL1 and FL2, it is preferred for tri- and polyvalent compounds to be present in at least one of the two components. These preferably being tri- and polyvalent isocyanates such as MTI. Hereby the degree of cross-linking of the plastic colour layer can be influenced, a higher degree of cross-linking generally being accompanied by an improved autoclave resistance.

As colour agent FL3, both solids and liquids known to the person skilled in the art and which are suitable for the present invention come into consideration. Solid colour agents are often referred to as colour pigments and are separated into organic and inorganic colour pigments. The following are notable suitable pigments: i. red or magenta pigments: Pigment Red 3,5,19,22,31,38,43,48:1,48:2,48:3,48:4,48:5,49:1,53:1,57:1,57:2,58:4,63:1,81,81:1,81:2,81:3,8 1:4,88, 104, 108, 112, 122, 123, 144, 146, 149, 166, 168, 169, 170, 177, 178, 179, 184, 185,208,216,226,257, Pigment Violet 3, 19,23,29, 30, 37, 50 and 88; ii. blue or cyan pigments: Pigment Blue 1,15,15:1,15:2,15:3,15:4,15:6,16,17-1,22,27,28,29,36 and 60; iii. green pigments: Pigment Green 7, 26, 36 and 50; iv. yellow pigments: Pigment Yellow 1, 3,12,13,14,17,34,35,37,55,74,81,83,93,94,95,97,108,109,110,128,137,138,139,153,154,155,15 7,166,167,168, 177, 180, 185 and 193 and v. white pigments: Pigment White 6, 18 and 21.

Materials with a melting point lower than 10° C. are considered as solvent FL4. Too small quantities of solvent have a disadvantageous effect on the uniformity and autoclave resistance of the outer or outermost plastic colour layer. In principle, all solvents known to the person skilled in the art and which are suitable for the process according to the invention come into consideration. Polar solvents are preferred. Here, protic and aprotic solvents are suitable, of which aprotic polar solvents are preferred, of which esters and ketones, acetone for example, are particularly preferred. As ester, above all ethylacetate, N-propylacetate or methoxypropylacetate come into consideration.

As additives FL5 which are different from FL1 to FL4, all those which are known to the person skilled in the art and which are suitable for the process according to the invention come into consideration. Preferably, waxes, soaps or tensides are employed, and stabilisers are employed for increasing the storability of the colour layer precursor. Often the additives have a melting point above 30° C. and preferably above 50° C. The viscosity and surface tension of the liquid colour layer precursor can be set using the additives.

Particularly preferred in the process according to the invention are at least two components which can react with each other, which are suitable for forming a poly-additive, preferably a polyurethane. Commercial examples of note are the products Gecko™ of the Huber Group, Germany, and XP Flint of the Flint Group, Luxembourg.

The application of the liquid colour agent layer precursor solution can be achieved by every printing process considered suitable by the person skilled in the art. Particularly notable printing processes are flat printing, digital printing, relief printing and depression printing, preferably depression printing. In the process according to the invention it is preferred that the liquid colour layer precursor solution is applied to the surface by means of a dimpled surface with a multitude of depressions which gather the colour layer precursor solution and which are preferably dish-like. The dimpled surface which comprises a multitude of depressions is preferably present on a roller which scoops the liquid colour layer precursor solution out of a reservoir container. It is further preferred that as uniform a filling of the depressions as possible is guaranteed by means of a homogeniser, preferably in the form of a scraper. The uniformity of the plastic colour layer improved in this way has a positive effect on the autoclave resistance. Further, it is preferred in the process according to the invention that the surface of the pre-composite is pressed onto the dished surface by means of a pressing agent, preferably a press roller.

The outer or outermost cross-linked plastic colour layer is often the outermost layer of a colour system which has 2 to 8, preferably 3 to 6 plastic colour layers of different colours. Using several plastic colour layers of different colours, mostly primary colours, various combination colours can be created on the surface of the sheet-like composite. Provided that the colour system has two or more plastic colour layers, the one or more plastic colour layers next to the outer or outermost cross-linked plastic colour layer can have the same composition as outer or outermost cross-linked plastic colour layer except for the colour. Furthermore, the application of the liquid colour layer precursor solution can be repeated according to the number of plastic colour layers.

Furthermore it is preferred in the process according to the invention that the surface is a cross-linked primer plastic layer, optionally filled with inorganic particles. Preferably, the primer plastic layer contains less colour agent than the plastic colour layer and can also contain no colour agent. In the case that the primer colour layer comprises inorganic particles, it preferable for them to have a particle size in a range from 3 to 12 μm and particularly preferably a particle size in a range from 3 to 7 μm. As inorganic particles, all metal oxides and sulphates which appear suitable to the person skilled in the art come into consideration. Notable metal oxides are SiO compounds, such as Aerosil or clay, TiO₂ or AIO compounds, such as Al₂O₃. As metal sulphates BaSO₄ and CaSO₄ in particular are considered. In addition to the white colour of the inorganic particles, it is preferred that these are hydrophilated with oxygen groups, preferably OH groups. Both the filled primer plastic layer and the plasma treatment, which can alternatively both be present in the pre-composite, serve to increase the mechanical durability during autoclaving of the plastic colour layer present thereon. As well as the hydrophilation the addition of inorganic, mostly white, particles to the primer plastic layer serves to ensure the colour fastness of the outer or outermost plastic colour layer and in particular to avoid its de-colouration.

The outer or outermost colour agent plastic layer is created by a poly-addition or even a poly-condensation as a sub set of poly-addition. In this connection it is preferred that an irradiation is carried out. To this end it is preferred that the surface furnished with the liquid colour layer precursor layer solution is passed underneath the radiation source(s) and these are preferably enclosed, wherein the radiation sources preferably form part of the casing in order to further contribute to the autoclave resistance of the plastic colour layer.

Any radiation source known to the person skilled in the art which is suitable for curing is employed in the process according to the invention. Infrared radiation sources or hot air nozzles are preferred.

Further, it is preferred in the process according to the invention that the irradiation is followed by a heat treatment at a temperature in a range from 80 to 160° C., preferably in a range from 100 to 140° C. and particularly preferably in a range from 110 to 130° C.

Additionally, it is preferable in the process according to the invention that the plastic colour layer has a surface weight in a range from 0.4 to 15 g/m² and particularly preferably in a range from 0.5 to 1.5 g/m². To this end it is similarly advantageous to apply the colour layer precursor in a range from 0.4 to 15 g/m² and particularly preferably in a range form 0.5 to 1.5 g/m².

Moreover, it is preferred in the process according to the invention that the plastic colour layer has a thickness in a range from 0.4 to 15 μm and preferably in a range from 0.5 to 1.5 μm. To this end it is similarly advantageous for the colour layer precursor to be applied in a range from 0.4 to 15 μm and particularly preferably in a range from 0.5 to 1.5 μm. The thickness is determined by means of incisions.

The above mentioned measures of the process according to the invention, individually or as a combination of at least two of these measures, contribute to an increase in the resistance of the subsequently produced plastic colour layer during autoclaving. Too hard a plastic colour layer often leads to a peeling off of areas of plastic colour layer, since these become too brittle under the autoclaving conditions or do not bind sufficiently from the outset. The binding can be determined according to DIN EN ISO 2409. Too soft a plastic colour layer, on the other hand, often leads to a scratching of plastic colour layer regions since this is caused, under the conditions of the autoclaving, in particular by mechanical stress such as rubbing or chafing with the container mountings and particularly in an autoclaving in which the container is agitated. The abrasion resistance can be determined according to ASTM D5264-98.

A further contribution to the solution of at least one of the aforementioned objects is made by a sheet-like composite, comprising
V1. at least an outer cross-linked plastic colour layer comprising a colour agent;
V2. a carrier layer; and
V3. a thermoplastic plastic layer;
wherein a cross-linked primer plastic layer, preferably comprising inorganic particles, is present in between the plastic colour layer and the carrier layer.

A further embodiment of the present invention relates to a container which is formed at least partially from a sheet-like composite according to the invention. The container according to the invention preferably comprises food stuff.

The embodiments given above in connection with the process according to the invention apply similarly to the sheet-like composite as a product, as well as for the constituents thereof and for the container formed therefrom. Likewise, the additional embodiments for the product and the container also apply to the process according to the invention.

The primer plastic layer, after being formed, for example by curing, has a layer thickness in a range from 0.5 to 5 μm, preferably in a range from 1.25 to 2 μm and particularly preferably in a range from 1.6 to 1.7 μm. As is the case with the other layers of the sheet-like composite, the layer thickness of the primer plastic layer can be determined by means of an incision in the sheet-like composite.

The primer plastic layer can be obtained by any means which seems appropriate to the person skilled in the art. Preferably it is obtained by application of a primer plastic precursor to the surface of a corresponding precursor to the sheet-like composite upon which the plastic colour layer which follows the primer plastic layer is intended to be present. Therefore, it is preferred in the process according to the invention that the liquid primer layer precursor solution comprises as components
FLp1 in a range from 5 to 40% by weight, preferably in a range form 10 to 30% by weight and particularly preferably in a range from 15 to 25% by weight, in each case in relation to the primer layer precursor solution, of a di- or polyalcohol, preferably di- and polyalcohols;
FLp2 less than 30% by weight, preferably in a range form 2 to 20% by weight and particularly preferably in a range from 5 to 10% by weight, in each case in relation to the primer layer precursor solution, of a di- or polyisocyanate, preferably di- and polyisocyanates;
FLp3 less than 40% by weight, preferably in a range from 5 to 30% by weight and particularly preferably in a range from 10 to 20% by weight, in each case in relation to the primer layer precursor solution, of inorganic particles;
FLp4 less than 15% by weight, preferably less than 10% by weight and particularly preferably less than 5% by weight, in each case in relation to the primer layer precursor solution, of additives which are different to FL1 to FL3 and FL5; and
FLp5 a solvent as a proportion of the primer layer precursor solution which is selected in such a way that the sum of all of the components FL1 to FL5 equals 100% by weight.

It is preferable according to the invention in connection with the sheet-like composite that the plastic colour layer has a surface with a contact angle of greater than 50°, preferably between 50 to 85°, particularly preferably 65 to 80° and most preferably 70 to 75°. The contact angle is determined according to the method described here. Generally a sheet-like composite is thus provided which comprises a plastic colour layer, wherein the plastic colour layer has a surface with a contact angle greater than 50°, preferably in a range from 60 to 80° and particularly preferably in a range from 70 to 75°. Such sheet-like composites are particularly suited as containers for autoclaving of food stuffs contained therein, and in so doing the colour and the information content on the containers are only marginally damaged, if at all. Therefore, containers made of sheet-like composites are employed in processes wherein food stuffs are autoclaved in these containers, in particular when these containers have been formed by folding a single piece of these composites, the above detailed conditions for the autoclaving being particularly preferable.

Preferably not just the primer layer precursor, but also the cross-linked primer plastic layer have more inorganic particles than the plastic colour layer, preferably at least 10% by weight and particularly preferably at least 50% by weight. Consequently, a primer plastic layer with inorganic particles, preferably white pigment, in a range from 20 to 55% by weight, preferably in a range from 30 to 50% by weight, and particularly preferably in a range from 35 to 45% by weight as well as further preferred in a range from 38 to 42% by weight, in each case in relation to the primer plastic layer, is particularly preferred according to the invention. In this way a particularly good resilience of the plastic colour layer a with brilliant colour impression is obtained.

Furthermore, a double or poly isocyanate is added to the primer layer precursor at 1 to 25% by weight, preferably 2 to 15% by weight and particularly preferably 5 to 10% by weight, in each case relative to the primer layer precursor. This is preferably effected prior to the application of the primer layer precursor onto the surface of the relevant sheet-like composite precursor. There should preferably be no more than 2 days, preferably not more than 1 day and particularly preferably not more than 12 hours between the addition and the application.

The following exemplary figures show:

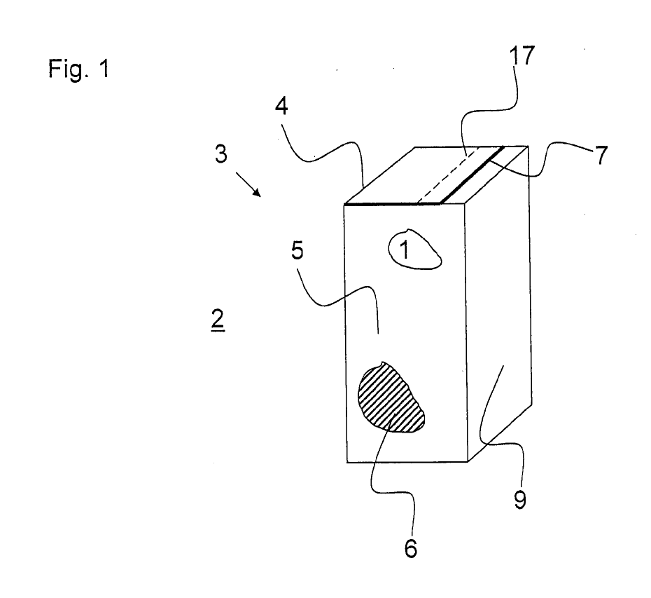

FIG. 1 a perspective view of a container obtainable by the process according to the invention;

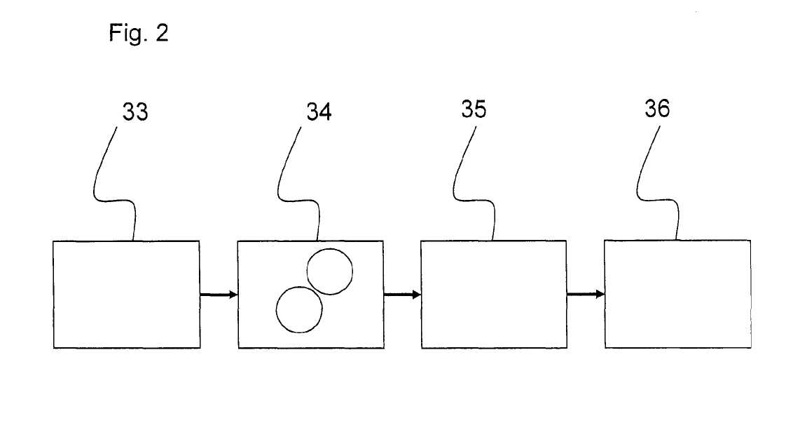

FIG. 2 a schematic representation of the course of the process according to the invention;

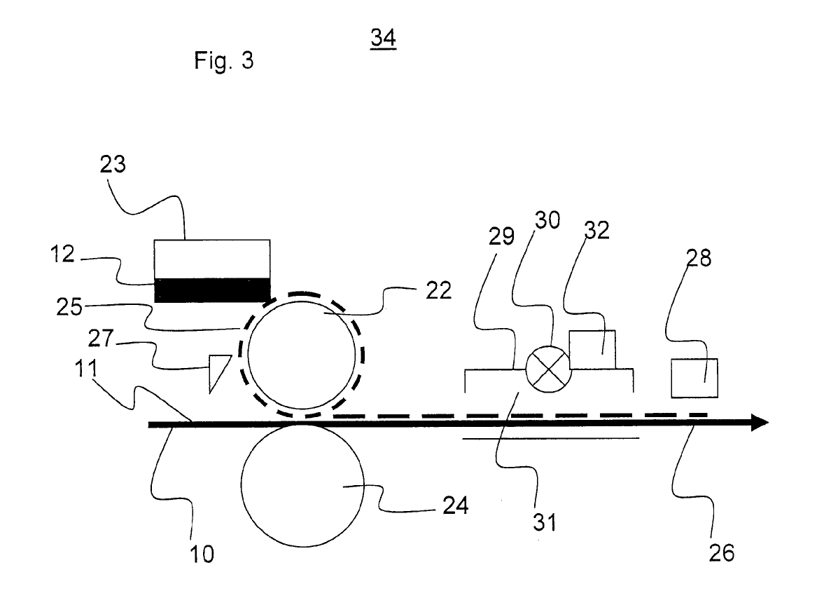

FIG. 3 a schematic representation of an apparatus for the application of the plastic colour layer;

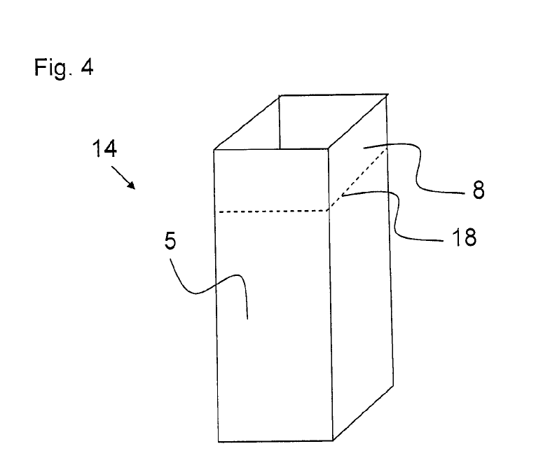

FIG. 4 a perspective view of an open container obtainable by the process according to the invention;

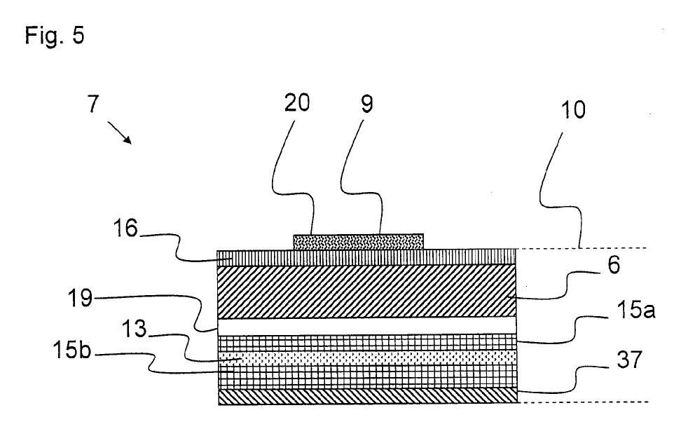

FIG. 5 a schematic cross section through a sheet-like composite with an outermost plastic colour layer;

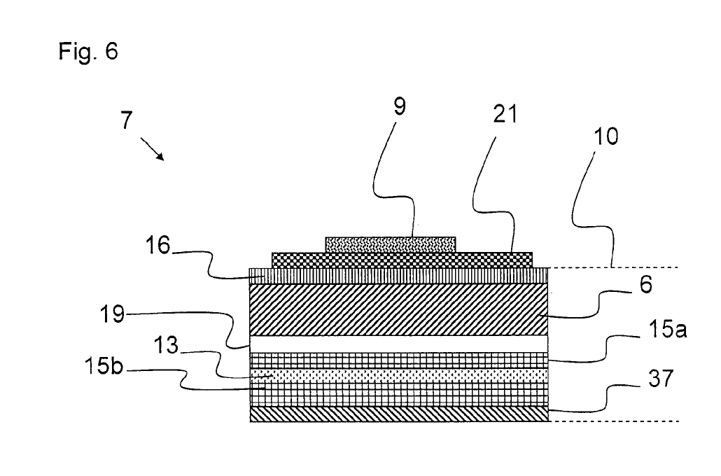

FIG. 6 a schematic cross section through a sheet-like composite with an outermost plastic colour layer;

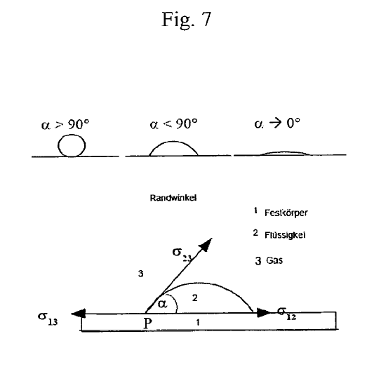

FIG. 7 schematic representation of contact angle determination.

FIG. 1 shows the perspective view of a container 3 obtainable by the process according to the invention which is essentially cuboid shaped and has a multiplicity of edges 4, which form the border between container walls 5 and as such create an interior space 1, which is separated from the environment by the container 3. The walls of the container 5 have a single piece carrier layer 6 running through the entire sheet-like composite 7 made out of cardboard, shown schematically as an excerpt, and an outermost cross-linked plastic colour layer 9. On the top side of the container 3 a linear perforation 17 is present for easy opening of the container.

Firstly, the manufacture of a pre-composite 33 is detailed in FIG. 2. It shows an apparatus in which a pre-composite 10 is manufactured, for example those described more closely in FIGS. 5 and 6, normally by melt co-extrusion. This is followed by a printing unit 34 which is described in more detail in FIG. 3 and in which the plastic colour layer 9 is applied to the pre-composite 10, in order to produce the printed picture or decoration 26. Following this is a filling area 35 in which the packaging blank produced in the printing unit 34 is converted into an open container 14, for example as represented in FIG. 4, by folding and sealing or bonding, in order to be filled with the food stuff and subsequently sealed by folding and sealing or bonding. Following the filling area 35 is an autoclave area 36. Here, the closed container 3, which is filled with food stuff, is autoclaved under pressure and in a moist atmosphere, this preferably being carried out in a pressure chamber which is particularly preferably designed for agitating the container, in particular through rotation. The production of the pre-composite 33 and the printing unit 34 are often spatially separated from the filling area 35 and the autoclave area 36. In this case it is preferred that the filling area 35 and the autoclave area 36 are provided at a food processing facility.

FIG. 3 shows in schematic cross-section a printing unit 34 which is suitable for depression printing, wherein a pre-composite 10 with a surface 11 passes between a dimpled roller 22 and a pressure roller 24, the surface 11 facing the dimpled roller 22. The dimpled roller 22 has a dimpled surface 25 comprising a multitude of depressions which accept a colour layer precursor solution 12 from the colour layer precursor solution reservoir 23 into the multitude of depression of the dished surface 25, the colour layer precursor solution being smoothed using a scraper. The colour layer precursor solution 12 present in the depressions of the dished surface 25 is deposited onto the surface 11 of the pre-composite 10 and next passes in a liquid, solvent comprising state through a enclosure 29 with an irradiation source 30 which forms a warm gas atmosphere 31 in the enclosure 29 via a warm air nozzle 32. By this means, the initially liquid colour agent precursor solution 12 is cured by cross linking into a plastic colour layer 9 by at least partial extraction of solvents and by a heat initiated chemical reaction, normally a poly-addition, forming a decoration 26. The solvent liberated thereby is extracted via a solvent extractor 29.

FIG. 4 shows the perspective schematic view of an open container 14, wherein the container wall 5 has a sealable portion 8 which is separated by a folded edge 18.

A preferred embodiment of a sheet-like composite 7 to be employed for the container of the process according to the invention is shown in FIG. 5. In the sheet-like composite of this preferred embodiment in the closed container 3, there follows in order, from outside to inside, a partially present plastic colour layer 9 which corresponds to the printed pattern or decoration 26, with colour agent 20 which is preferably made out of fine particle pigment, a further plastic layer 16, a carrier layer 6, an additional layer 19, a first adhesive layer 15a, an aluminium layer as a barrier layer 13, a second adhesive layer 15b and a further thermoplastic plastic layer 37.

The pre-composite 10, upon which the plastic colour layer 9 is present, has the composition shown between the stroked lines.

In FIG. 6 is shown a further embodiment of a sheet-like composite for a container of the process according to the invention. In addition to the layers shown in FIG. 5, this sheet-like composite has a primer plastic layer 21 between the thermoplastic plastic layer 16 and the plastic colour layer.

Suitable adhesive agents are in particular thermoplastic polymers, preferably polyolefins, in particular polyethylenes, and polypropylenes or a mixture thereof, which are functionalised in order to form as secure a bonding as possible with the bordering layers by means of a chemical reaction. Preferred adhesive agents are polyethylene or polypropylene, which in each case in copolymerised with a function carrying monomer, in particular maleic acid anhydride. Such adhesive agents are grouped under the trade names Orevac™, Admer™, Lotader™ or Plexar™ Different adhesive agents can also be mixed together to give an adhesive agent blend.

The further plastic layer or layers and the additional layer or layers are preferably made out of thermoplastic polymers. Here come into consideration, generally, all those known to the person skilled in the art for the production of a sheet-like composite, in particular when this is to be formed into a container, which is to be subjected to heat and moisture treatment filled or not filled with food stuff Suitable thermoplastic polymers are polymers obtained by chain-polymerisation, polyolefins in particular, polycyclic olefin co-polymer (POC), polyethylene and polypropylene being preferred. Products of poly-condensation reactions or poly ring opening reactions are similarly suitable as thermoplastic polymers, with polyamides, polyesters and polyurethanes being particularly preferred. As polyurethanes, thermoplastic polyurethanes are preferred, preferably with a weight average molecular weight in a range from 2,000 to 2,000,000 g/mol and particularly preferably 4,000 to 50,000 g/mol. The polyurethanes preferably have a density in a range from 1.01 to 1.40 and particularly preferably in a range from 1.08 to 1.25 g/cm³. Polyurethanes of this type are commercially obtainable under the trade name Elastogran™. Particularly suitable polyesters are polybutyleneterephthalate, polycarbonate, polyethyleneterephthalate, polyethylenenaphthalate and preferably polyethyleneterephthalate. Polyesters have weight average molecular weights in a range from 5,000 to 2,000,000 g/mol and preferably in a range from 8,000 to 100,000 g/mol and densities in a range from 1.25 to 1.70 and preferably in a range from 1.30 to 1.45 g/cm³. A typical, commercially available polyester is CLEARTUF™ P60. Additionally, mixtures of polymers obtained from chain-polymerisation and polymers obtained by poly-condensation reactions or poly ring opening reactions are suitable polymers according to the invention. Polymers obtained by chain-polymerisation are, however, preferred. In a further modification of the present invention the adhesive agents are present as a mixture with the thermoplastic polymers.

Preferred polyethylenes are HDPE, LDPE, LLDPE, and PE as well as mixtures of at least two thereof. Preferred polypropylenes are isotactic, syndiotactic and atactic polypropylenes as well as mixtures of at least two thereof Preferred polyesters are acrylate based polyesters. Generally, the thermoplastic polymers for the various layers of a sheet-like composite for the manufacture of a container according to the invention are selected in such a way that they have a melting point that lies above the temperature load to which the container is exposed in the process according to the invention.

Measuring Methods:

Generally, where they are not here otherwise specified, all measurements are carried out at 22° C., under atmospheric pressure and with a room humidity in a range from 50 to 70%. Wherever no measuring method is given here, the most recent ISO standard as of 10 Oct. 2009 applies for the determination of the relevant quantity.

Determination of Contact Angle:

The determination is made according to TAPPI T558 om-06 with the following proviso: A drop of water (4 μl volume) is placed on the surface to be determined (here the plastic colour layer). After a settling time of roughly 500 ms the sample which is lying on the sample plate with the droplet lying on top is digitally captured by a camera whose optical axis cuts the cross section of the sample (see FIG. 7). The level is marked by hand, the evaluation of the angle is undertaken by the software of the apparatus used for the measurement OCA 20 of the company Dataphysics, which investigates the contact angle α of the corresponding sample.

### LIST OF REFERENCES

1 interior space

2 environment/outer side of container

3 container

4 edge

5 container wall

6 carrier layer

7 composite

8 sealable portion

9 plastic colour layer

10 pre-composite

11 surface

12 colour layer precursor solution

13 barrier layer

14 open container

15 adhesive agent a, b

16 thermoplastic plastic layer

17 perforation

18 folding edge

19 additional layer

20 colour agent

21 primer plastic layer

22 dimpled roller

23 colour layer precursor solution reservoir

24 pressure roller

25 dimpled surface

26 decoration

27 scraper

28 solvent extractor

29 enclosure

30 radiation source

31 warm gas atmosphere

32 warm air blower

33 pre-composite manufacture

34 printing unit

35 filling area

36 autoclave area

37 further thermoplastic plastic layer

1. A process for the preparation of a closed container, which separates an internal space filled with food stuff from an environment, from at least one sheet-like composite which has at least one edge, comprising the steps:
a) providing a sheet-like composite comprising
a1. at least one outer cross-linked plastic colour layer, comprising a colour agent, wherein the plastic colour layer comprises a poly-addition product;
a2. a carrier layer; and
a3. a thermoplastic plastic layer;
b) forming the sheet-like composite to obtain an open container, wherein the plastic colour layer faces onto the environment and the plastic layer faces onto the internal space;
c) filling the open container with a food stuff;
d) closing the open container to obtain the closed, filled container; and
e) preserving the food stuff in the closed, filled container in a pressure chamber under a chamber pressure of more than 1 bar at a temperature in a range from more than 100 to 140° C. in the presence of steam.

2. The process according to claim 1, wherein the outer plastic colour layer is an outermost plastic colour layer.

3. The process according to claim 1, wherein the composite is obtainable by a series of steps comprising:
providing a pre-composite with a surface, comprising the carrier layer;
applying a liquid colour layer precursor solution onto the surface; and
curing the colour layer precursor into the plastic layer colour layer.

4. The process according to claim 3, wherein the colour layer precursor solution comprises
FL1, a di- or polyalcohol,
FL2, a di- or polyisocyanates,
FL3, a colour agent
FL4, 20 to 90% by weight, relative to the colour layer precursor solution, or a solvent, and
FL5, optionally additives which differ from FL1 to FL4

5. The process according to claim 3, wherein the curing is effected using irradiation.

6. The process according to claim 5, wherein the irradiation is performed by a heat treatment at a temperature in a range from 80 to 160° C.

7. The process according to claim 3, wherein the surface is treated with a plasma before the application of the liquid colour layer precursor solution onto the surface.

8. The process according to claim 3, wherein the surface has a surface tension in a range from 38 to 44 Dyne.

9. The process according to claim 3, wherein the liquid colour layer precursor has a viscosity in a range from 0.05 to 0.3 Pa·s.

10. The process according to claim 3, wherein the liquid colour layer precursor solution is applied to the surface by means of a dimpled surface comprising a multitude of depressions.

11. The process according to claim 3, wherein the surface is a cross-linked primer plastic layer.

12. The process according to claim 1, wherein the plastic colour layer has a surface weight in a range from 0.4 to 15 g/cm².

13. The process according to claim 1, wherein the plastic colour layer has a thickness in a range from 0.5 to 2 μm.

14. The process according to claim 1, wherein at least 70% by volume of the internal space of the container is made up of a food stuff.

15. The process according to claim 1, wherein the container is made of a single carrier layer as part of the sheet-like composite.

16. The process according to claim 1, wherein the container is entirely made out of the carrier layer as part of the sheet-like composite.

17. The process according to claim 1, wherein the food stuff is preserved to an F₀ value from 0.01 to 50.

18. The process according to claim 1, wherein the closed, filled container is agitated during the preserving step.

19. A sheet-like composite, comprising
V1. at least one outer cross-linked plastic colour layer comprising a colour agent;
V2. a carrier layer; and
V3. a thermoplastic plastic layer;
wherein a cross-linked primer plastic layer is present between the plastic colour layer and the carrier layer.

20. The sheet-like composite according to claim 20, wherein the plastic colour layer has a surface with a contact angle greater than 50°.

21. A container at least partially constructed from a sheet-like composite comprising
V1. at least one outer cross-linked plastic colour layer comprising a colour agent;
V2. a carrier layer; and
V3. a thermoplastic plastic layer;
wherein a cross-linked primer plastic layer is present between the plastic colour layer and the carrier layer.

22. The container according to claim 21, wherein the container contains a food stuff
